(19) United States
(12) Patent Application Publication
(10) Pub. No.: US 2008/0290188 A1
(43) Pub. Date: Nov. 27, 2008

(54) FUEL INJECTOR NEEDLE HOUSING

(75) Inventors: Russell P. Zukouski, Bolingbrook, IL (US); Dean A. Oppermann, Plainfield, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/751,787

(22) Filed: May 22, 2007

(51) Int. Cl. F02M 47/02

(52) U.S. Cl. 239/90; 123/445

(57) ABSTRACT

A fuel injector for injecting fuel into a cylinder of an internal combustion engine includes an injector body and a needle valve. A feed passage (408) fluidly connects a needle chamber (402) with a source of high pressure fuel. The needle chamber (402) is formed in a needle housing (400) and has a centerline (X) extending along its length. The needle valve is located in the needle chamber (402). A collection cavity (410) is formed in the needle housing (400) and in fluid communication with the needle chamber (402). The collection cavity (410) is positioned between the needle chamber (402) and the feed passage (408). The collection cavity (410) is advantageously substantially symmetrical about a plane that is perpendicular to the centerline (X) of the needle chamber (402).

### FIELD OF THE INVENTION

This invention relates to internal combustion engines, including but not limited to needle housings for fuel injectors for use with internal combustion engines.

### BACKGROUND OF THE INVENTION

Internal combustion engines include crankcases having a plurality of cylinders. The cylinders contain pistons whose reciprocating motion due to combustion events may be transferred through a crankshaft to yield a torque output of the engine. Often, engine crankcases are made of cast metal, and include passages integrally formed therein for the transfer of various fluids from one location of the engine to another. Fluids typically transferred through passages in an engine include coolant, air, fuel, oil, and so forth.

The combustion events within engine cylinders are the result of combustion of a combustible mixture of oxygen and fuel. In modern engines, fuel is injected directly into the cylinder by a fuel injector that is operably associated with each cylinder. There are many different types of fuel injectors in use. Some fuel injectors use pressurized fuel which they inject into a cylinder, while others receive fuel at a low pressure which they then pressurize internally before injecting a quantity of the pressurized fuel into the cylinder.

A pressure at which fuel is injected into the cylinder is known to be related to a degree of vaporization of fuel into the cylinder. Fuel vaporization, especially in compression ignition engines, directly affects the quality and efficiency of combustion. As a general rule, the higher the injection pressure is, the better the combustion quality is, and thus the more economical the operation of the engine is. Moreover, efficient combustion in the cylinder is known to yield lower emission levels.

Known fuel injector designs have limitations as to the injection pressure various components of the fuel injector can tolerate. Known injectors exposed to higher injection pressures in a laboratory and/or simulation setting has experienced failures. These and other issues may be avoided as follows.

### SUMMARY OF THE INVENTION

A fuel injector for injecting fuel into a cylinder of an internal combustion engine includes an injector body and a needle valve. A feed passage fluidly connects a needle chamber with a source of high pressure fuel. The needle chamber is formed in a needle housing and has a centerline extending along its length. The needle valve is located in the needle chamber. A collection cavity is formed in the needle housing and in fluid communication with the needle chamber. The collection cavity is positioned between the needle chamber and the feed passage. The collection cavity is advantageously symmetrical about a plane that is perpendicular to the centerline of the needle chamber.

### BRIEF DESCRIPTION OF THE DRAWINGS

FIG. 1 is a cross-section view of a fuel injector having a needle housing with a collection cavity.

FIG. 2 and FIG. 3 are detailed cross-section views of the needle housing shown as part of the injector of FIG. 1.

FIG. 4 and FIG. 5 are detailed cross-section views of a needle housing having a collection cavity in accordance with the invention.

FIG. 6 and FIG. 7 are detailed cross-section views of alternate embodiments for needle housings having collection cavities in accordance with the invention.

### DESCRIPTION OF A PREFERRED EMBODIMENT

The following describes an apparatus for enabling operation of a fuel injector at higher pressure levels than was previously possible. The embodiments described herein are alternative designs for a needle housing of a fuel injector that advantageously require a minimum degree of changes to other components of the fuel injector.

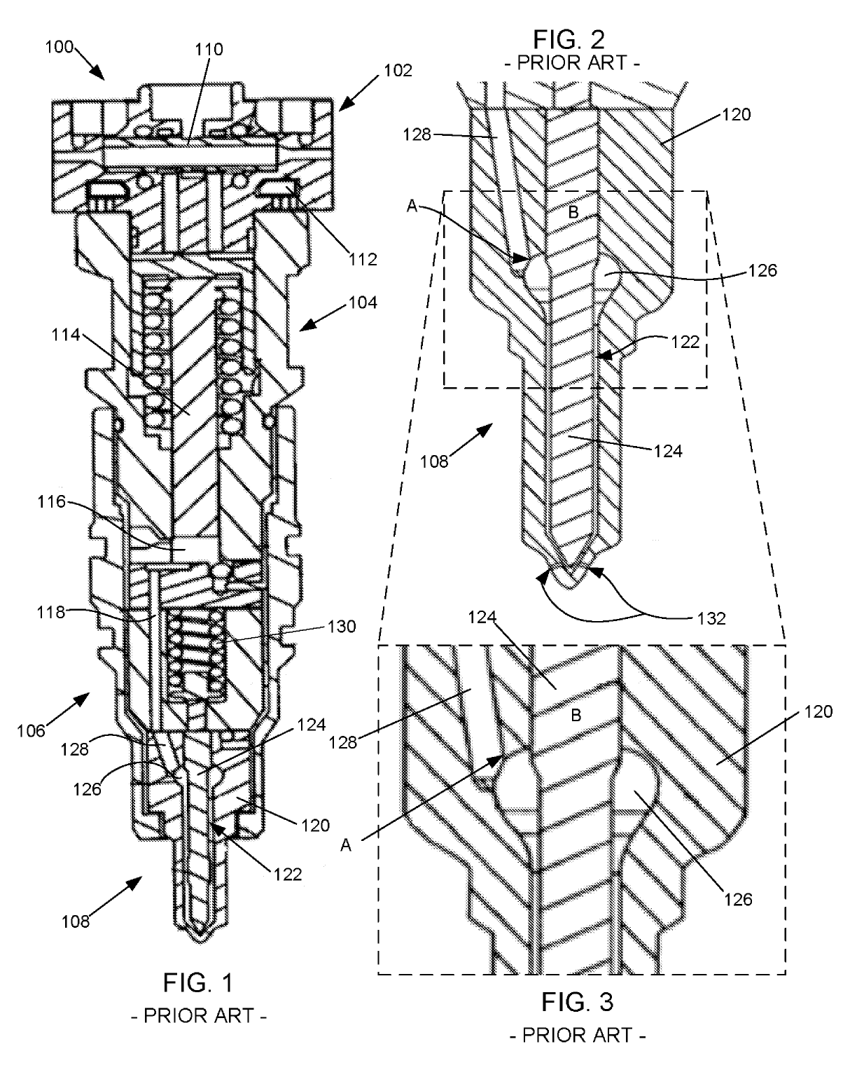

Various section views of a known fuel injector 100 are shown in FIG. 1, FIG. 2, and FIG. 3 for illustration. The fuel injector 100 is a unit injector capable of injecting fuel at a high pressure. The injector 100 is able to admit fuel at a low pressure and amplify the pressure of the fuel to a high pressure. The fuel injector 100 includes an actuation-fluid valve portion 102, an intensification portion 104, a needle-valve portion 106, and a needle housing portion 108.

The actuation-valve portion 102 includes a spool valve 110 that is actuated by at least one electronic (e.g. solenoid) actuator 112. During operation of the injector 100, the spool valve 110 intermittently opens to admit an actuation fluid, typically fuel or oil, which is at a high pressure. The actuation fluid is routed to the intensification portion 104 that includes an intensification piston 114. The intensification piston 114 fluidly communicates with an intensification chamber 116. An area of the intensification piston 114 that is exposed to actuation fluid is larger than an opposite area thereof that is open to the intensification chamber 116, such that the pressure of the actuation fluid is amplified in the intensification chamber 116.

At times when the spool valve 110 isolates the intensification piston 114 from actuation fluid at the high pressure, the intensification chamber 116 is usually occupied by fuel at an initial pressure. The initial pressure may be a pressure that is lower than or about equal to the high pressure of the actuation fluid. The intensification piston 114 becomes exposed to actuation fluid at the high pressure when the spool valve 110 opens. The pressure of fuel contained in the intensification chamber 116 increases to a final or injection pressure that is well above the high pressure of the actuation fluid due to the amplification effect of the intensifier piston.

Fuel at the injection pressure exits the intensification chamber 116 and travels via a nozzle supply passage 118, through the needle-valve portion 106, and into the needle housing portion 108 of the injector 100. The needle housing portion 108 includes a needle housing 120. The needle housing forms a needle cavity 122 which houses a needle valve 124. A collection cavity 126 fluidly communicates with the nozzle supply passage 118 through a feed passage 128. The collection cavity 126 is formed in the needle housing 120 and surrounds a portion of the needle 124 that is close to the needle-valve portion 106.

At times when fuel at injection pressure enters the collection cavity 126, a pressure is applied onto the needle 124 that pushes the needle toward the needle-valve portion 106 and against a spring 130 that is contained therein. When a force on the needle 124 due to fuel at the injection pressure in the collection cavity 126 surpasses a force of the spring 130, the needle valve 124 moves toward the needle-valve portion 106 and exposes one or more nozzle openings 132 to fuel in the collection cavity 126. Fuel begins exiting the injector 100 through the openings 132. This constitutes an injection event. When fuel pressure in the collection cavity 126 diminishes, the spring 130 pushes the needle 124 away from the needle-valve portion 106, and the flow of fuel through the openings 132 ceases.

The collection cavity 126 has a “kidney-shaped” cross section. This shape has been found preferable in the past because it allows for relatively easy entry of fuel into the collection cavity 126, it provides a larger cross-section for pushing the needle 124 during an opening event, and it slopes inward to aid the flow of fuel toward the nozzle openings 132 when the needle 124 is open. Nevertheless, the shape of the collection cavity 126 unavoidably creates a sharp corner and a thin material condition at the intersection between the feed passage 128 and the collection cavity 126.

The injector 100 described thus far, and other similar injectors, are typically designed to operate below a maximum fuel injection pressure of about 2400 bar (240 MPa). It is desirable to inject fuel at higher pressures during operation of the engine to achieve improved fuel economy and lower emissions. Operation of an injector like the injector 100 in a laboratory environment at pressures higher than 2400 bar, for example, at pressures at or above 2800 to 3000 bar (280 to 300 MPa), have caused failures and cracking of the needle housing 120 at an area thereof that is close to the intersection of the feed passage 128 with the collection cavity 126. Often, cracks will develop at a stress concentration point, A, which propagate through the needle housing 120 and into a point, B, in the needle 124. These cracks cause structural issues and lead to fuel leakage or inoperability of the injector 100. Past efforts to address the issue of cracking have included use of stronger materials for the needle housing 120, internal smoothing of the sharp edge at point A, and so forth. These efforts have proved partially effective in increasing the needle-housing's strength, but have also added cost and time to the manufacturing processes used to make the needle housing 120.

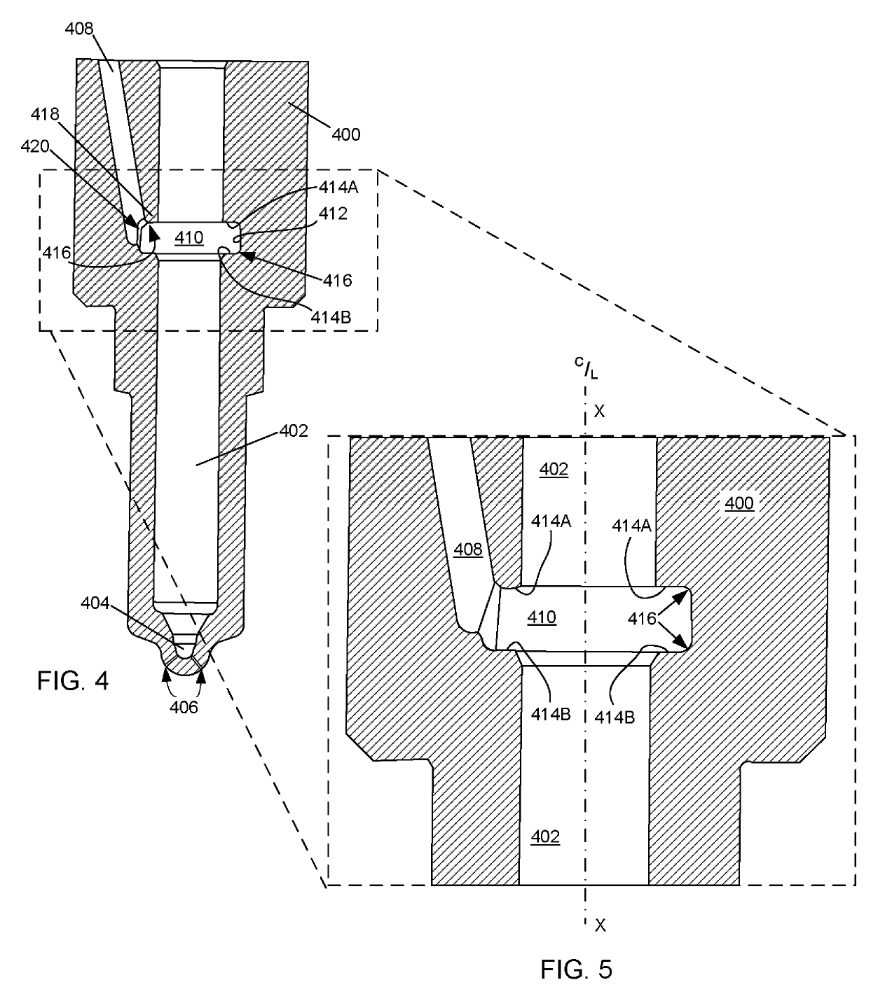

Two cross-sectional views of an improved needle housing 400 are shown in FIG. 4 and FIG. 5. The needle housing 400 in these figures is shown in an unassembled state, without a needle disposed therein for clarity.

The needle housing 400 forms a needle cavity 402 that terminates at a tip 404 having one or more nozzle openings 406 formed therein. A feed passage 408 is formed in the needle housing 400 and fluidly communicates with a collection cavity 410. The collection cavity 410 surrounds a portion of the needle cavity 402. The collection cavity 410 advantageously has a rounded-rectangular cross section. The collection cavity 410 is surrounded by a lateral cylindrical surface 412 and two disk surfaces 414A and 414B. The cylindrical surface 412 interfaces with each of the two disk surfaces 414A and 414B along two curved surfaces or fillets 416. The collection cavity 410 advantageously has a substantially rectangular cross section. A major surface of the lateral cylindrical surface 412 is advantageously substantially perpendicular to each of the two disk surfaces 414A and 414B to at least partly form the substantially rectangular cross section of the cavity 410.

The needle housing 400 is advantageously capable of operating without the formation of cracks at or near a high stress concentration area 418 that is located around an interface region 420 between the feed passage 408 and the collection cavity 410. Hence, a fuel injector (not shown) containing the needle housing 400 is advantageously capable of operating under ultra-high-pressure fuel injection pressures, or, pressures that are at or substantially above 2800 to 3000 bar (280 to 300 MPa). The collection cavity 410 as formed in the needle housing 400 is advantageously symmetrical about a plane that is perpendicular to a major axis, X, of the needle cavity 402. The axis X can also be considered as a centerline along the length of the cavity 402.

A detail view in cross-section of an alternate embodiment for a needle housing 600 is shown in FIG. 6. The needle housing 600 forms a needle cavity 602 that terminates at a tip (not shown) having one or more nozzle openings formed therein. A feed passage 608 is formed in the needle housing 600 and fluidly communicates with a collection cavity 610. The collection cavity 610 surrounds a portion of the needle cavity 602.

The collection cavity 610 advantageously has a substantially circular cross section that is blended with the needle cavity 602 with fillets. The collection cavity 610 is surrounded by a lateral concave surface 612 and two fillet surfaces 614A and 614B. The concave surface 612 interfaces with each of the two fillet surfaces 614A and 614B in a smooth fashion. The portion of the collection cavity 610 that is bound by the concave surface 612 may be described as having a substantially toroidal shape, with a center axis, Y, being the centerline of the needle cavity 602. As is known, a toroid is a surface generated by a closed plane curve, in this case a portion of a circle 615 making up the cross section of the concave surface 612, rotated about a line, the centerline Y, which lies in the same plane as the curve 615 but does not intersect it. The curve 615 has a center, C, and a radius, R. A magnitude of the radius R determines an internal volume of the collection cavity 610. In the embodiment shown, a distance, d, between the center C of the curve 615 and the centerline Y of the needle cavity 602 determines the shape and position of the collection cavity 610.

The needle housing 600 is advantageously capable of operating without the formation of cracks at or near a high stress concentration area 618 that is located around an interface region 620 between the feed passage 608 and the collection cavity 610. Operation of the needle housing 600 under conditions of ultra-high injection pressure is possible because of the advantageously increased thickness of material in the area 618, and also because of the smooth shape of the needle housing 600 at and/or around the area 618. Hence, a fuel injector (not shown) containing the needle housing 600 is advantageously capable of operating under ultra-high-pressure fuel injection pressures, or, pressures that are at or substantially above 2800 to 3000 bar (280 to 300 MPa).

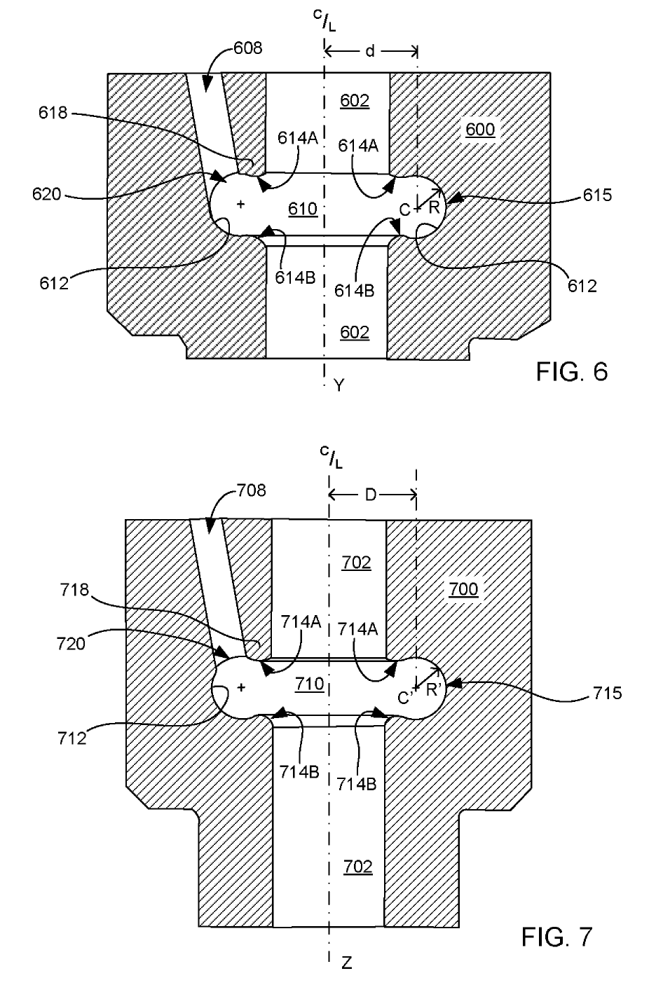

A detail view in cross-section of an alternate embodiment for a needle housing 700 is shown in FIG. 7. The needle housing 700 forms a needle cavity 702 that terminates at a tip (not shown) having one or more nozzle openings formed therein. A feed passage 708 is formed in the needle housing 700 and fluidly communicates with a collection cavity 710. The collection cavity 710 surrounds a portion of the needle cavity 702.

In many respects, the collection cavity 710 is similar to the collection cavity 610 described above in relation to the needle housing 600 shown in FIG. 6. The collection cavity 710 advantageously has a substantially circular cross section that is blended with the needle cavity 702 with fillets. A concave surface 712 surrounds a portion of the collection cavity 710 and interfaces with each of two fillet surfaces 714A and 714B in a smooth fashion. The portion of the collection cavity 610 that is bound by the concave surface 712 may be described as having a substantially toroidal shape, with a center axis, Z, being the centerline of the needle cavity 702. A curve 715 that outlines the concave surface has a center, C′, and a radius, R′. In the embodiment shown, a distance, D, between the center C′ of the curve 715 and the centerline Z of the needle cavity 702 determines the shape and position of the collection cavity 710. It is noted that the distance D in the embodiment of FIG. 7 is larger than the distance d of the embodiment shown in FIG. 6.

The needle housing 700 is advantageously capable of operating without the formation of cracks at or near a high stress concentration area 718 that is located around an interface region 720 between the feed passage 708 and the collection cavity 710. Operation of the needle housing 700 under conditions of ultra-high injection pressure is possible because of the advantageously increased thickness of material in the area 718, because of the smooth shape of the needle housing 700 at and/or around the area 718, and because of the shape of the opening at the interface region 720 that advantageously has no sharp edges. Hence, a fuel injector (not shown) containing the needle housing 700 is advantageously capable of operating under ultra-high-pressure fuel injection pressures, or, pressures that are at or substantially above 2800 to 3000 bar (280 to 300 MPa).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A fuel injector for injecting fuel into a cylinder of an internal combustion engine, comprising:
an injector body that includes a needle valve;
a feed passage fluidly connecting a needle chamber with a source of high pressure fuel, wherein the needle chamber is formed in a needle housing and has a centerline extending along the length thereof, and wherein the needle valve is disposed in the needle chamber;
a collection cavity formed in the needle housing and disposed in fluid communication with the needle chamber, wherein the collection cavity is disposed between the needle chamber and the feed passage;
wherein the collection cavity is symmetrical about a plane that is perpendicular to the centerline of the needle chamber.

2. The fuel injector of claim 1, wherein the collection cavity has a substantially rectangular cross section.

3. The fuel injector of claim 2, wherein the collection cavity is substantially bound by a lateral cylindrical surface, and a first and second disk surfaces; wherein each of the first and second disk surfaces interface with the lateral cylindrical surface with fillets.

4. The fuel injector of claim 1, wherein the collection cavity has a substantially circular cross section.

5. The fuel injection of claim 4, wherein the collection cavity is bound laterally by a concave surface, and wherein the collection cavity is bound by a first and second filet surfaces that are disposed on alternating sides of the lateral concave surface.

6. The fuel injector of claim 5, wherein a portion of the collection cavity that is bound by the concave surface has a substantially toroidal shape, wherein the toroidal shape is defined by a circular segment having a center and a radius, wherein the circular segment is rotated about the centerline of the needle chamber to form the toroid.

7. The fuel injector of claim 6, wherein a volume of the collection cavity increases as a distance of the center is disposed further away from the centerline and as the radius increases.

8. The fuel injector of claim 6, wherein the circular segment does not intersect the centerline.

9. A needle housing for a fuel injector for use with an internal combustion engine, comprising:
a needle chamber extending along a centerline of the needle housing, wherein the needle chamber is open on one end, and wherein the needle chamber is bound by a tip portion on an opposite end, wherein at least one nozzle opening is formed in the tip portion;
a feed passage formed in the needle housing, wherein the feed passage fluidly connects an injection fuel opening of the needle housing with the needle chamber;
a collection cavity formed in the needle housing, wherein the collection cavity is at least partially disposed around a portion of the needle cavity, and wherein the collection cavity fluidly connects the feed passage with the needle chamber;
wherein the collection cavity is symmetrical about a plane that is perpendicular to the centerline of the needle housing.

10. The needle housing of claim 9, wherein the collection cavity has a substantially rectangular cross section.

11. The needle housing of claim 10, wherein the collection cavity is substantially bound by a lateral cylindrical surface, and a first and second disk surfaces; wherein each of the first and second disk surfaces interface with the lateral cylindrical surface with fillets.

12. The needle housing of claim 9, wherein the collection cavity has a substantially circular cross section.

13. The needle housing of claim 12, wherein the collection cavity is bound laterally by a concave surface, and wherein the collection cavity is bound by a first and second filet surfaces that are disposed on alternating sides of the lateral concave surface.

14. The needle housing of claim 13, wherein a portion of the collection cavity that is bound by the concave surface has a substantially toroidal shape, wherein the toroidal shape is defined by a circular segment having a center and a radius, wherein the circular segment is rotated about the centerline of the needle chamber to form the toroid.

15. The needle housing of claim 14, wherein a volume of the collection cavity increases as a distance of the center is disposed further away from the centerline and as the radius increases.

16. The needle housing of claim 14, wherein the circular segment does not intersect the centerline.

17. A fuel injector for an internal combustion engine having a needle valve portion that includes a needle housing, the needle housing comprising:
a needle disposed in a needle chamber that is formed in the needle housing, wherein the needle chamber has a centerline;
a high-pressure fuel passage extending from a high-pressure fuel supply into the needle chamber, wherein a substantially cylindrical cavity having a base diameter that is perpendicular to the centerline of the needle housing intersects the needle chamber and fluidly connects the needle chamber with the high-pressure fluid passage.

18. The fuel injector of claim 17, wherein the substantially cylindrical cavity is bound by a lateral cylindrical surface that surrounds the centerline, a first disk surface that is perpendicular to the centerline and has a central opening where the cavity intersects the needle chamber, and a second disk surface that is perpendicular to the centerline and has an additional central opening where the cavity intersects the needle chamber.

19. A fuel injector for an internal combustion engine having a needle valve portion that includes a needle housing, the needle housing comprising:
a needle disposed in a needle chamber that is formed in the needle housing, wherein the needle chamber has a centerline;
a high-pressure fuel passage extending from a high-pressure fuel supply into the needle chamber, wherein a substantially toroidal cavity defined by rotation of a circular segment around the centerline of the needle housing intersects the needle chamber and fluidly connects the needle chamber with the high-pressure fluid passage.
